(19) United States
(12) Patent Application Publication
(10) Pub. No.: US 2004/0089508 A1
(43) Pub. Date: May 13, 2004

(54) Negative pressure type brake hydraulic pressure generating device

(75) Inventors: Kaoru Tsubouchi, Kariya (JP); Akihiko Miwa, Kariya (JP); Tomoyasu Sakai, Kariya (JP); Koichi Hashida, Kariya (JP); Haruo Arakawa, (US)

Correspondence Address: BURNS DOANE SWECKER & MATHIS L L P, POST OFFICE BOX 1404, ALEXANDRIA, VA, 22313-1404, US

(73) Assignee: ADVICS CO., LTD.

(21) Appl. No.: 10/701,459

(22) Filed: Nov. 6, 2003

(30) Foreign Application Priority Data
Nov. 7, 2002 (JP) 2002-323523

(51) Int. Cl. B60T 11/00

(52) U.S. Cl. 188/357

(57) ABSTRACT

It is aimed to improve brake feeling of a negative pressure type brake hydraulic pressure generating device in which the stroke on the operating side can be set independently of the stroke on the output side. A spring for setting the stroke on the operating side is formed of coil springs arranged in series to impart the spring nonlinear characteristics, thereby biasing a piston, which can be moved axially relative to a power plate and includes a control valve for introducing atmospheric air, in the return direction.

### BACKGROUND OF THE INVENTION

This invention relates to a negative pressure type brake hydraulic pressure generating device which makes it possible to set a stroke on the operating side independently of a stroke on the output side (affecting the fluid amount consumed in the brake circuit), and particularly to a negative pressure type brake hydraulic pressure generating device which achieves good brake feeling.

A widely used conventional brake hydraulic pressure generating device is structured such that the brake operating force is amplified by means of a booster, and the amplified force is applied to a master cylinder. In this type of device, since the operating stroke of the brake pedal (hereinafter referred to as pedal stroke) directly corresponds to the amount of fluid discharged from the master cylinder, when an additional hydraulic device such as antilock system is activated, its influence inevitably reflects the pedal stroke.

For example, JP patent publication 2002-173016 proposes a brake hydraulic pressure generating device which copes with this problem. In the device of the publication, the interior of a fixed shell is partitioned into a constant pressure chamber and a variable pressure chamber by an axially slidable power plate. Inside the power plate, a piston is provided so as to be axially movable relative to the power plate, biased in the retracting direction by a spring (that is, stroke-power converter) for setting the stroke on the operating side. Also, inside this piston, which has its rear portion protruding outwardly from the fixed shell, a control valve and an input shaft are provided.

The constant pressure chamber is connected to a negative pressure source such as the intake manifold of the engine. Also, the variable pressure chamber communicates with the constant pressure chamber during non-operation of the brakes, and communicates with the atmosphere during operation of the brakes. Communication is changed over by a control valve built in the piston.

When the brake pedal is stepped in, the input shaft, which receives the pedal operating force, is pushed in. With relative movement between the piston and the input shaft at this time, the control valve first shuts off communication between the variable pressure chamber and the constant pressure chamber, and then brings the variable pressure chamber into communication with the atmosphere. Thus, the atmospheric air which depends on the brake operating amount flows into the variable pressure chamber, creating a pressure difference between the constant pressure chamber and the variable pressure chamber.

Under this pressure difference, the power plate advances, applying its force to the master cylinder. At this time, the piston, too, advances under the differential pressure between the constant pressure chamber and the variable pressure chamber to a position where the pressure difference balances with the force of the spring. The piston stroke at this time is substantially equal to the stroke of the input shaft. The reaction force upon operation of the pedal is generated when the pressure in the master cylinder is applied to the tip of the input shaft. The pressure in the master cylinder is generated depending on the pressure in the variable pressure chamber.

In the thus structured device of the JP patent publication 2002-173016, since the power plate and the piston are combined so as to be axially movable relative to each other, it is possible to set the pedal stroke irrespective of the consumed fluid amount of the brakes.

In a brake hydraulic generating device for a vehicle, it is ideal that in the initial period of step-in of the brake pedal, the output hydraulic pressure rise slowly, as shown by solid line in FIG. 3, and thereafter the rise grow. But in the device of the JP patent publication 2002-173016, since the spring for setting the stroke on the operating side shows linear characteristics, this requirement cannot be fulfilled, so that optimum brake feeling was not obtainable.

An object of this invention is to improve the brake feeling by imparting nonlinear characteristics to the spring.

### SUMMARY OF THE INVENTION

According to this invention, there is provided a negative pressure type brake hydraulic pressure generating device comprising, a constant pressure chamber connected to a negative pressure source, a variable pressure chamber into which when a brake is operated, atmospheric air of an amount corresponding to the brake operating amount is introduced, a fixed shell for separating the negative pressure chamber and the constant pressure chamber from outside, an input shaft actuated by an operating force applied to a brake operating member, a piston which receives a pressure in the variable pressure chamber and a pressure in the constant pressure chamber on pressure receiving surfaces thereof and produces an advancing thrust by a differential pressure between the pressures, a spring for biasing the piston in a retracting direction, a power plate which receives the pressures in the variable pressure chamber and the constant pressure chamber on pressure receiving surfaces thereof and transmits an advancing thrust under the differential pressure, and a control valve built in the piston for controlling the pressure in the variable pressure chamber by selectively bringing the variable pressure chamber into communication with the atmosphere or the negative pressure source depending on the relative movement between the input shaft and the piston, the power plate and the piston being axially movable relative to each other, the spring comprising a plurality of springs arranged in series so that the load of the spring relative to a brake operating amount will increase sharply from some time after the start of push-in of the brake pedal.

In order to impart nonlinear properties to the spring, springs having different spring constants may be combined, or a stopper may be provided which restricts the deflection amount of at least one of the plurality of springs arranged in series to below a preset value such that defletion restriction by the stopper will develop while the input shaft is being pushed in to cause change in load increase of the spring relative to the brake operating amount.

By providing the spring in the fixed shell, compactness of the device can be achieved. By providing the spring outside of the fixed shell, assembling, replacement, etc. of the spring becomes easy.

By combining springs having different spring constants, or providing a stopper which restricts the deflection amount of at least one of the plurality of springs arranged in series to below a preset value such that defletion restriction by the stopper will develop while the input shaft is being pushed in to cause change in load increase of the spring relative to the brake operating amount, the load of the spring relative to the brake operating amount increases sharply from an intermediate point, so that relation between the brake operating amount and the output hydraulic pressure approaches an ideal curve, thus improving the brake feeling.

### BRIEF DESCRIPTION OF THE DRAWINGS

Other features and objects of the present invention will become apparent from the following description made with reference to the accompanying drawings, in which:

FIG. 1 is a sectional view showing the brake hydraulic pressure generating device of a first embodiment;

FIG. 2 is a sectional view showing the brake hydraulic pressure generating device of a second embodiment; and

FIG. 3 is a graph showing an ideal curve of the stroke versus output hydraulic pressure relation.

### DETAILED DESCRIPTION OF THE PREFERRED EMBODIMENT

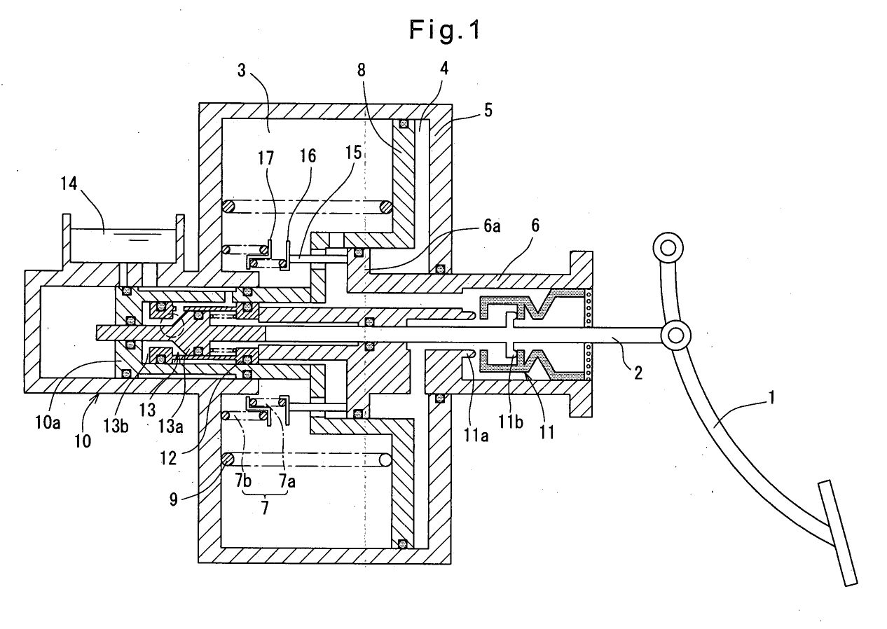

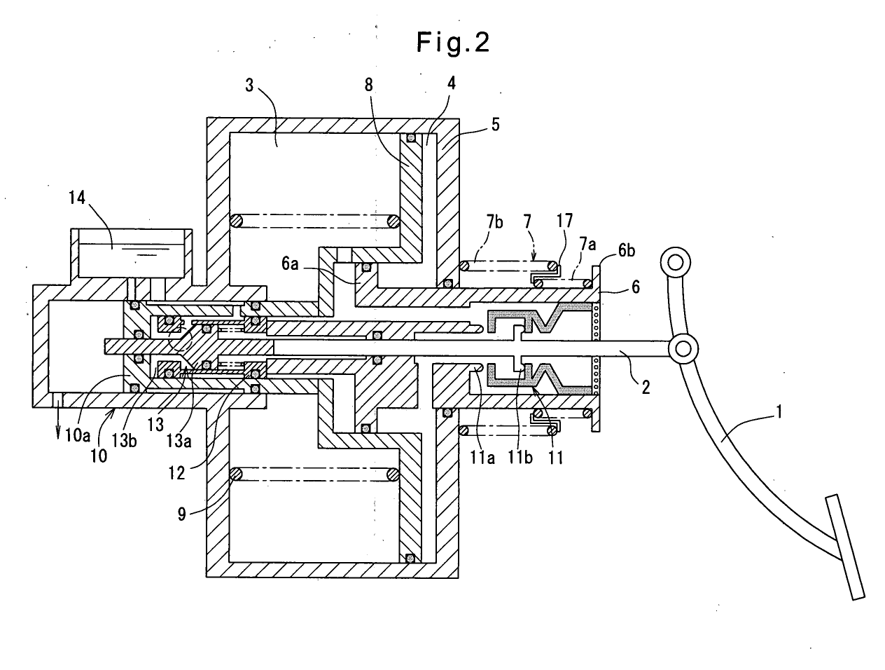

The embodiment of this invention will be described with reference to FIGS. 1 and 2. The negative pressure type brake hydraulic pressure generating device of FIG. 1 is shown with its structure simplified for convenience.

It includes a brake pedal 1, an input shaft 2 that transmits the brake operating force, a constant pressure chamber 3 connected to a negative pressure source such as an intake manifold of an engine, a variable pressure chamber 4 into which an atmospheric air corresponding to the brake operating amount is introduced during operation of the brakes, a fixed shell 5 separating the constant pressure chamber 3 and the variable pressure chamber 4 from outside, a piston 6 that oppositely receives the pressures in the constant pressure chamber and variable pressure chamber on pressure receiving surfaces and produces an advancing thrust under a differential pressure between the pressures, a spring 7 biasing the piston 6 in a retracting direction for setting the stroke on the operating side, a power plate 8 that oppositely receives the pressures in the constant pressure chamber 3 and the variable pressure chamber 4 on its pressure receiving surfaces, a spring 9 biasing the power plate 8 in a retracting direction, a master cylinder 10 connected to wheel brakes (not shown), a control valve 11 built in the piston 6 for introducing atmospheric air, a piston 12 built in a master cylinder piston 10a, a relative movement restricting means 13 for restricting the relative movement between the input shaft 2 and the master cylinder piston 10a, and a reservoir 14.

The piston 6 has a large-diameter portion 6a at its tip, which is airtightly and axially slidably mounted on a cylindrical portion of the power plate 8. The piston 6 receives the pressures in the constant pressure chamber 3 and the variable pressure chamber 4 on its pressure receiving surfaces opposite to each other. When a differential pressure between them is produced, thrust is produced, so that the piston 6 advances leftwardly in the figure. On the front surface of the piston 6, a plurality of circumferentially arranged pins 16 are provided which extend through the power plate 8 and protrude into the constant pressure chamber 3. At the tip of each pin 16, a retainer 17 is provided. The spring 7 is disposed between the retainer 17 and the inner wall of the fixed shell 5.

The spring 7 comprises a combination of two coil springs 7a and 7b arranged in series. As shown, the coil springs 7a and 7b have different diameters. Their axial length can be shortened by arranging them so as to partially overlap with a retainer 17 having an inner flange and an outer flange disposed therebetween. The retainers 16 and 17 also function as stoppers and restrict the deflecting amount of the coil spring 7a to below a preset value.

With the illustrated brake hydraulic pressure generating device, the coil spring 7a has a smaller spring constant than the spring 7b. But if the deflection of one of the springs is restricted by providing stoppers as shown, the object of the invention can be achieved even if two coil springs having identical spring constants are combined. If springs having different spring constants are used by combining in series, the stoppers may not be used. But by providing the stoppers, the change point of load increase of the springs will stabilize and the setting of the stroke and load characteristics will be easier.

The spring here is a combination of compression springs. But the springs used may be tension springs. Also, dampers having functions equivalent to springs may be used. Springs in this invention cover such members, too.

Two or more springs having different characteristics, or two or more springs in which all but one undergo deflection restriction may be combined so that load change points exist at a plurality of points.

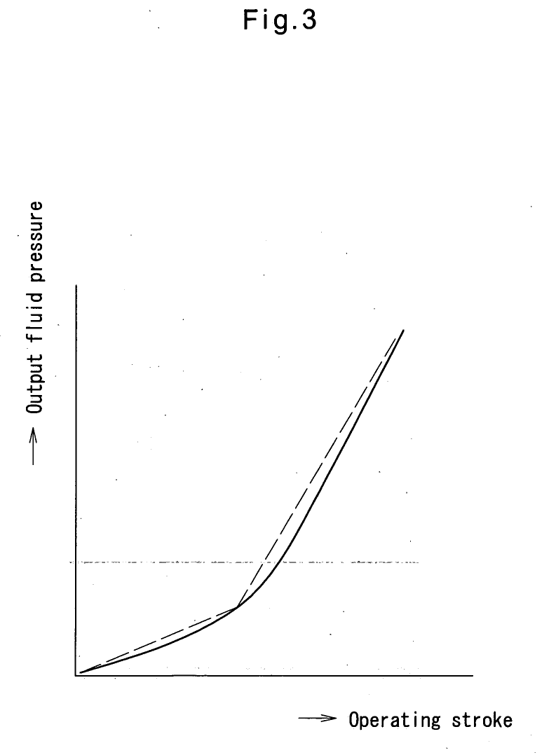

If the spring 7 is formed of a plurality of springs having different characteristics or springs some of which undergo deflection restriction, the load of the spring 7 increases slowly in the initial period of operation of the brake pedal 1, and from the deflection restriction point of the coil spring 7a by the stoppers, the load increase becomes steep, so that the relation between the pedal stroke and the output hydraulic pressure approaches an ideal curve as shown by dotted line in FIG. 3. Thus, compared with conventional brake hydraulic generating devices, which use springs having linear characteristics, brake feeling improves.

The relative movement restricting means 13 comprises a valve mechanism 13a having a valve seat formed on the piston 12 and a valve portion formed at the tip of the input shaft 2, and a fluid chamber 13b provided between the piston 12 and the master cylinder piston 10a. The relative movement restricting means 13 fixes the relative position between the input shaft 2 and the master cylinder piston 10a when the capacity of the device reaches or approaches the assisting limit, i.e. when the pressure difference between the variable pressure chamber 4 and the atmosphere (outside of the fixed shell 5) disappears or falls below a predetermined value, thereby preventing the brake pedal from being pushed in without increase in the reaction force when the driver increases the brake pedal stepping force thereafter. Also, it serves to reflect the increase of the pedal stepping force after the assisting limit on the master cylinder pressure. The relative movement restricting means 13 is a preferable element but is not essential.

With the illustrated brake hydraulic pressure generating device, the reaction force to the operation of the brake pedal 1 is imparted by the hydraulic pressure generated in the master cylinder 10.

With the thus structured device, during non-operation in which the brake pedal 1 is not stepped in, the control valve 11 shuts off the variable pressure chamber 4 from the atmosphere, and keeps the variable pressure chamber 4 in communication with the constant pressure chamber 3. Thus, the pressure in the variable pressure chamber 4 is equal to the pressure in the constant pressure chamber 3, so that the power plate 8, which receives the pressures in both chambers on the pressure receiving surfaces, does not move but stops at the illustrated position.

When the brake pedal 1 is stepped in and the input shaft 2 is pushed leftwardly in FIG. 1, the control valve 11 shuts off the variable pressure chamber 4 from the constant pressure chamber 3. During non-braking, the control valve 11 is pulled by the input shaft 2 and compressed, but when the input shaft 2 advances, it is elastically restored and expands.

Thus, until the tip of the control valve 11 touches a valve seat 11a formed on the piston 6, the contact with a valve seat 11b formed on the input shaft 2 is maintained. Thus the variable pressure chamber 4 is first shut off from the constant pressure chamber 3. Thereafter, the control valve 11 separates from the valve seat 11b, so that the variable pressure chamber 4 communicates with the atmosphere. Now atmospheric air is introduced into the variable pressure chamber 4, so that the pressure in the variable pressure chamber will rise. Thus, a pressure difference is produced between the constant pressure chamber 3 and the variable pressure chamber 4. Under the pressure difference, the power plate 8 advances, so that the force amplified by the power plate 8 is applied to the master cylinder. Thus, a hydraulic pressure corresponding to the brake operating amount is produced in the master cylinder 10. The power plate 8 will advance to a position where the thrust produced by the differential pressure balances with the reaction force from the master cylinder.

Under the pressure difference produced between the constant pressure chamber 3 and the variable pressure chamber 4, an advancing thrust is imparted to the piston 6, too, so that the piston 6 also advances to a position where the thrust balances with the reaction force from the spring 7. Since the piston 6 follows the input shaft 2 so that when the movement of the input shaft 2 stops, the control valve 11 will be in such a position as to shut off the variable pressure chamber 4 from both the constant pressure chamber 3 and the atmosphere, the stroke of the piston 6 at this time is substantially equal to the stroke of the input shaft 2.

But since the reaction force from the spring 7 is given by the spring 7a, which is smaller in spring constant, in the initial stage of brake operation, and it is given by the spring 7b after the retainer 16 has touched the retainer 17 (after deflection has been restricted by the stoppers), increase in the pressure difference between the constant pressure chamber 3 and the variable pressure chamber 4 relative to the stroke is small in the initial stage of brake operation, but increases after deflection restriction by the stoppers. Thus, the rise of the output hydraulic pressure of the master cylinder 10 is moderate in the initial stage of brake operation and becomes steep after an intermediate point, so that the brake feeling improves.

Also, with the illustrated device, when the brake pedal 1 is stepped in hard, so that the pressure in the variable pressure chamber 4 reaches the assisting limit, the movement of the piston 6 will stop at a position where the variable pressure chamber 4 is under the atmospheric pressure. Thus the state in which through the control valve 11, the variable pressure chamber 4 communicates with the atmosphere is maintained.

In this state, if the brake pedal is stepped in with additional force, relative movement develops between the input shaft 2 and the piston 12, so that the valve mechanism 13a will close, thus stopping the flow of fluid from the fluid chamber 13b to the reservoir 14. Thus, the relative position between the input shaft 2 and the master cylinder piston 10a is fixed, so that the brake pedal 1 is prevented from being pushed in without increase in the reaction force. Further, the force due to the additional pedal step-in is transmitted to the master cylinder piston 10a through the fluid sealed in the fluid chamber 13b, so that the increase in the stepping force after the assisting limit is reflected on the master cylinder pressure.

FIG. 2 shows a brake hydraulic pressure generating device of the second embodiment. With the device of the second embodiment, a spring 7 is arranged on the outer periphery of a portion of the piston 6 exposed to the atmosphere. As in FIG. 1, as the spring 7, coil springs 7a and 7b having different diameters and different spring constants are used. The spring 7 is mounted between a flange 6b provided on the outer periphery of the rear end of the piston 6 and the outer surface of the fixed shell 5. The flange 6b is an alternative to the retainer 16 of FIG. 1. This flange 6b and a retainer 17 disposed between the two springs form a stopper for restricting deflection of the coil spring 7a.

If the spring 7 is provided outside the fixed shell 5 in this way, while it is disadvantageous in compactness compared with the device of FIG. 1, it is advantageous in that assembling and replacement of the spring are easy. Since other structures and operation are the same as with the device of FIG. 1, identical numerals are attached to elements which are the same as those of FIG. 1 and their description is omitted.

As described above, in the brake hydraulic pressure generating device of this invention, since the spring for setting the stroke on the operating side is formed of a plurality of springs and these springs are given such nonlinear characteristics that the load increase relative to the stroke is small initially and grows from an intermediate point, relation between the operating stroke and the output hydraulic pressure approaches the ideal curve, and thus it is possible to improve the brake feeling.

Also, since a plurality of springs are combined, the stroke-load characteristics can be easily and optionally set. In particular, in the arrangement in which deflection restriction is carried out for some of the springs by providing the stopper, the stroke-load characteristics can be easily set, so that the load change point stabilizes.

What is claimed is:

1. A negative pressure type brake hydraulic pressure generating device comprising,
a constant pressure chamber connected to a negative pressure source,
a variable pressure chamber into which when a brake is operated, atmospheric air of an amount corresponding to the brake operating amount is introduced,
a fixed shell for separating said negative pressure chamber and said constant pressure chamber from outside,
an input shaft actuated by an operating force applied to a brake operating member,
a piston which receives a pressure in said variable pressure chamber and a pressure in said constant pressure chamber on pressure receiving surfaces thereof and produces an advancing thrust by a differential pressure between said pressures,
a spring for biasing said piston in a retracting direction,
a power plate which receives said pressures in said variable pressure chamber and said constant pressure chamber on pressure receiving surfaces thereof and transmits an advancing thrust under said differential pressure, and
a control valve built in said piston for controlling the pressure in said variable pressure chamber by selectively bringing said variable pressure chamber into communication with the atmosphere or said negative pressure source depending on the relative movement between said input shaft and said piston,
said power plate and said piston being axially movable relative to each other,
said spring comprising a plurality of springs arranged in series so that the load of said spring relative to a brake operating amount will increase sharply from some time after the start of push-in of the brake pedal.

2. A negative pressure type brake hydraulic pressure generating device as claimed in claim 1 wherein a stopper is provided which restricts the deflection amount of at least one of said plurality of springs arranged in series to below a preset value such that defletion restriction by said stopper will develop while said input shaft is being pushed in to cause change in load increase of said spring relative to the brake operating amount.

3. A negative pressure type brake hydraulic pressure generating device as claimed in claim 1 wherein that springs having different spring constants are combined to cause change in the load increase of said spring relative to the brake operating amount.

4. A negative pressure type brake hydraulic pressure generating device as claimed in any of claims 1-3 wherein a pin is provided on said piston so as to extend through said power plate and protrude into said constant pressure chamber, and wherein said spring is provided between a retainer provided at the tip of said pin and the inner surface of said fixed shell.
